(19) United States
(12) Patent Application Publication
(10) Pub. No.: US 2019/0357317 A1
(43) Pub. Date: Nov. 21, 2019

(54) INDUCTION HEATING DEVICE HAVING IMPROVED CONTROL ALGORITHM AND CIRCUIT STRUCTURE

(71) Applicant: LG Electronics Inc., Seoul (KR)

(72) Inventors: Younghwan KWACK, Seoul (KR); Seongho SON, Seoul (KR); Jaekyung YANG, Seoul (KR); Yongsoo LEE, Seoul (KR)

(21) Appl. No.: 16/216,166

(22) Filed: Dec. 11, 2018

(30) Foreign Application Priority Data
May 16, 2018 (KR) 10-2018-0056188

(51) Int. Cl. H05B 6/06; H05B 6/44; H05B 6/04

(52) U.S. Cl. CPC H05B 6/06; H05B 6/04; H05B 6/44

(57) ABSTRACT

The present disclosure relates to an induction heating device having an improved control algorithm and an improved circuit structure. In one embodiment of the present disclosure, an induction heating device includes: a first board having, thereon: a first working coil; a first inverter for performing a switching operation to apply a resonant current to the first working coil; and a first control unit configured for controlling an operation of the first inverter; and a second board having, thereon: a second working coil; a second inverter for performing a switching operation to apply a resonant current to the second working coil; and a second control unit configured for controlling an operation of the second inverter, wherein the first control unit is configured for enabling the first and second working coils to operate concurrently at an in-phase or 180-degrees out-of-phase.

### CROSS-REFERENCE TO RELATED APPLICATIONS

This application claims the priority of Korean Patent Application No. 10-2018-0056188 filed on May 16, 2018, in the Korean Intellectual Property Office, the disclosure of which is hereby incorporated by reference in its entirety.

### BACKGROUND

### 1. Technical Field

The present disclosure relates to an induction heating device having an improved control algorithm and an improved circuit structure.

### 2. Description of the Related Art

In homes and restaurants, cooking utensils using various heating methods to heat food are being used. Conventionally, gas ranges using gas as fuel have been widely used. However, in recent years, there has been a spread of devices for heating a cooking vessel such as a loaded object, such as a pot, by using electricity without using gas.

A scheme of heating a loaded object using electricity is divided into a resistive heating type and an inductive heating type. In the electrical resistive heating method, heat generated when current flows through a metal resistance wire or a non-metallic heating element such as silicon carbide is transmitted to the loaded object through radiation or conduction, thereby heating the loaded object. In the inductive heating method, when a high-frequency power of a predetermined magnitude is applied to the working coil, an eddy current is generated in the loaded object made of a metal by using a magnetic field generated around the working coil so that the loaded object itself is heated. The principle of the induction heating scheme is as follows. First, as power is applied to the induction heating device, a high-frequency voltage of a predetermined magnitude is applied to the working coil. Accordingly, an inductive magnetic field is generated around the working coil disposed in the induction heating device. When the flux of the inductive magnetic field thus generated passes through a bottom of the loaded object containing the metal as loaded on the induction heating device, an eddy current is generated inside the bottom of the loaded object. When the resulting eddy current flows in the bottom of the loaded object, the loaded object itself is heated.

The induction heating device generally has each working coil in each corresponding heated region to heat each of a plurality of objects (e.g., a cooking vessel).

In this connection, in order to operate multiple working coils concurrently, the corresponding working coils are arranged in a flex zone arrangement (in which two or more working coils are arranged side by side and operate simultaneously) or a dual zone arrangement (in which two or more working coils are arranged in a concentric manner and operate simultaneously).

Furthermore, in recent years, a zone free-based induction heating device has been widely used in which a plurality of working coils are evenly distributed over an entire region of the induction heating device (i.e., an entire region of a cooktop). For such a zone-free based induction heating device, when an object to be heated is loaded on a region corresponding to a plurality of working coil regions, the object may be inductively heated regardless of the size and position of the object.

In this connection, referring to FIG. 1 to FIG. 3, a conventional induction heating device having a plurality of working coils is illustrated. Referring to the drawings, a conventional induction heating device will be described.

FIG. 1 through FIG. 3 are circuit diagrams illustrating a conventional induction heating device.

First, as illustrated in FIG. 1, in the conventional induction heating device 10, directions of currents supplied to the plurality of working coils WC1 and WC2 are the same. Further, there is no circuit configuration capable of reversing or switching the direction of the current input/output to/from the working coils.

Due to this circuit structure, when implementing a flex mode (i.e., a concurrent operation mode of a plurality of working coils WC1 and WC2) or a high output mode, each working coil WC1 and WC2 must be controlled with the same phase and the same frequency. This may lead to a problem that the heated region is concentrated on the edges of the working coils WC1 and WC2 and, hence, the heated region of the object is limited to the region corresponding to the edges of the working coils WC1 and WC2.

Further, in the conventional induction heating device 10, an object-detection process is individually performed for each working coil WC1 and WC2. Thus, when the object is located on a region corresponding to an area between the first and second working coils WC1 and WC2, the device may not accurately detect whether the object is disposed on the first working coil WC1. In this case, even when the induction heating device 10 is set to the flex mode, the device cannot correctly execute the flex mode.

On the other hand, as illustrated in FIG. 2, a conventional induction heating device 11 allows one inverter (for example, first inverter IV1 or second inverter IV2) to synchronize a plurality of working coils WC1 to WC5 via relays R1 to R7. Therefore, when operating in the flex mode, a plurality of working coils WC1 to WC5 may be connected to one inverter IV1 or IV2 via the relays R1 to R7.

However, in the induction heating device 11 of FIG. 2, the directions of the currents supplied to the plurality of working coils WC1 to WC5 are the same. In this connection, there is no circuit configuration that allows inverting or switching the direction of the current input and output to and from the working coil.

Due to such a circuit structure, there is a limit in that, when at least two of the plurality of working coils WC1 to WC5 operate concurrently in the flex mode, the working coils WC1 to WC5 may be controlled only at the same phase and the same frequency. Further, a separate bridge diode is needed for high output implementation.

In the conventional induction heating device 11, an object-detection process is performed individually for each working coil WC1 to WC5. Thus, for example, when an object is located in a region corresponding to a position between the first and second working coils WC1 and WC2, the device may not accurately detect whether the object is disposed on the first working coil WC1. In this case, even when the induction heating device 11 is set to the flex mode, the device 11 cannot correctly execute the flex mode.

Finally, a conventional induction heating device 12 as illustrated in FIG. 3 may have the same problem as the induction heating device 10 in FIG. 1.

That is, in the induction heating device 12 of FIG. 3, the directions of the currents supplied to the plurality of working coils WC1 to WC4 are the same. In this connection, there is no circuit configuration that allows inverting or switching the direction of the current input and output to and from the working coil. Further, in the conventional induction heating device 13, an object-detection process is performed individually for each working coil WC1 to WC4.

The circuit structure and object-detection method as described above may lead to following defects: when the device operates in the flex mode, corresponding working coils may be controlled only at the same phase and at the same frequency; further, when an object is located on a region corresponding to an area between the working coils, the flex mode is not implemented properly; further, realizing a high output performance requires a separate bridge diode or a separate synchronization scheme.

### SUMMARY

A purpose of the present disclosure is to provide an induction heating device employing an improved object-detection algorithm for the flex mode operation (that is, for concurrent operations of multiple working coils).

Further, another purpose of the present disclosure is to provide an induction heating device with improved heating-region control and improved high output by means of an improved control signal delivery scheme.

The purposes of the present disclosure are not limited to the above-mentioned purposes. Other purposes and advantages of the present disclosure, as not mentioned above, may be understood from the following descriptions and more clearly understood from the embodiments of the present disclosure. Further, it will be readily appreciated that the objects and advantages of the present disclosure may be realized by features and combinations thereof as disclosed in the claims.

The induction heating device according to the present disclosure may include a main control unit for determining whether to enable a flex mode, based on an individual coil-based object-detection result for each of the plurality of working coils, and based on a coil set-based object-detection result for a set of the plurality of working coils. This may improve the object-detection algorithm when the device is in the flex mode.

Further, an induction heating device according to the present disclosure may include a first control unit which may supply a control signal with an inverted or non-inverted phase to a second inverter, or may include a first insulation-type circuit that inverts or non-inverts a phase of a control signal generated from a first control unit and provides the phase-inverted or non-inverted signal to the second inverter. This configuration may lead to improved heating-region control and enhanced high-power output.

In the induction heating device according to the present disclosure, the object-detection algorithm when the device is running in the flex mode may be improved. Thus, the user may easily check whether an object on an area corresponding to an area between the working coils is correctly positioned for enablement of the flex mode. Thus, a burden that the user should place the object on a correct position for driving of the induction heating device in the flex mode may be eliminated. Thus, user convenience may be improved.

Further, in the induction heating device according to the present disclosure, an improved circuit structure may improve heating-region control and enhance high-power output via the control signal delivery scheme. This reduces the object heating time and improves the accuracy of the heating intensity adjustment. Further, the object heating time reduction, and improved heating intensity adjustment accuracy may result in shorter cooking timing by the user, thereby resulting in improved user satisfaction.

Further specific effects of the present disclosure as well as the effects as described above will be described in conduction with illustrations of specific details for carrying out the invention.

### BRIEF DESCRIPTION OF DRAWINGS

FIG. 1 to FIG. 3 are circuit diagrams illustrating a conventional induction heating device.

FIG. 4 is a circuit diagram illustrating an induction heating device according to one embodiment of the present disclosure.

FIG. 5 is a schematic diagram illustrating a heated-region by a working coil according to an in-phase control signal delivery by a first control unit of FIG. 4.

FIG. 6 is a circuit diagram illustrating a heated-region by a working coil according to a 180-degrees out-of-phase control signal delivery by the first control unit of FIG. 4.

FIG. 7 is a flow chart illustrating an object-detection method by the induction heating device of FIG. 4.

FIG. 8 is a circuit diagram illustrating an induction heating device according to another embodiment of the present disclosure.

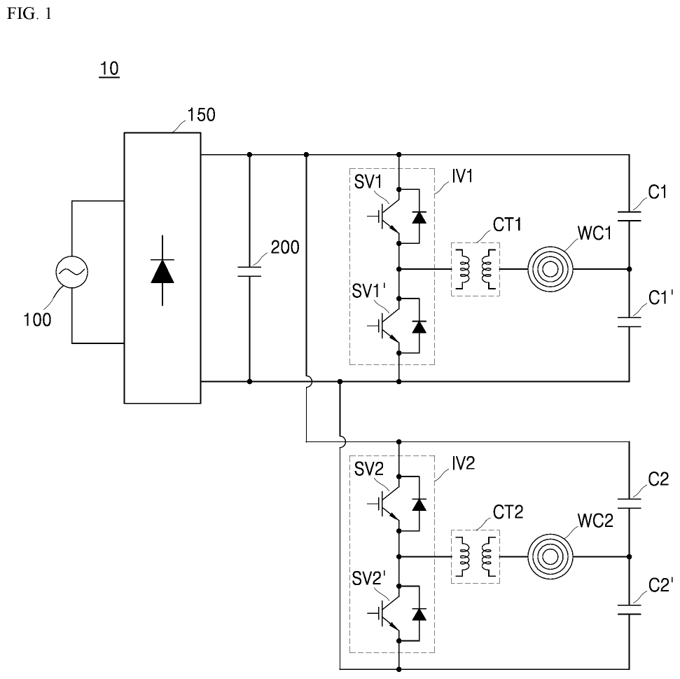

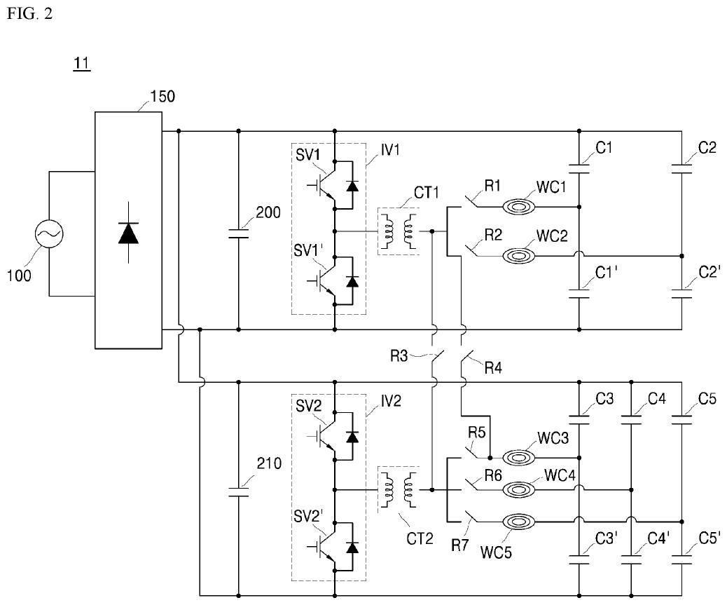

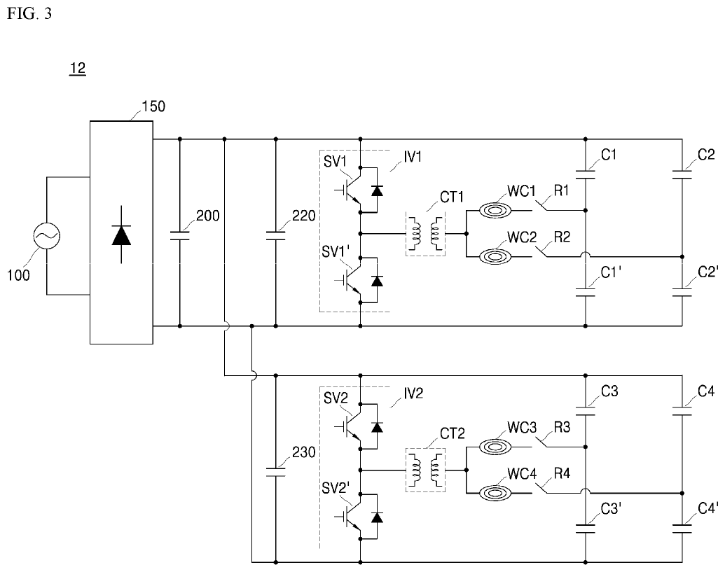

### DETAILED DESCRIPTION

The above objects, features and advantages will become apparent from the detailed description with reference to the accompanying drawings. Embodiments are described in sufficient detail to enable those skilled in the art in the art to easily practice the technical idea of the present disclosure. Detailed descriptions of well-known functions or configurations may be omitted in order not to unnecessarily obscure the gist of the present disclosure. Hereinafter, embodiments of the present disclosure will be described in detail with reference to the accompanying drawings. Throughout the drawings, like reference numerals refer to like elements.

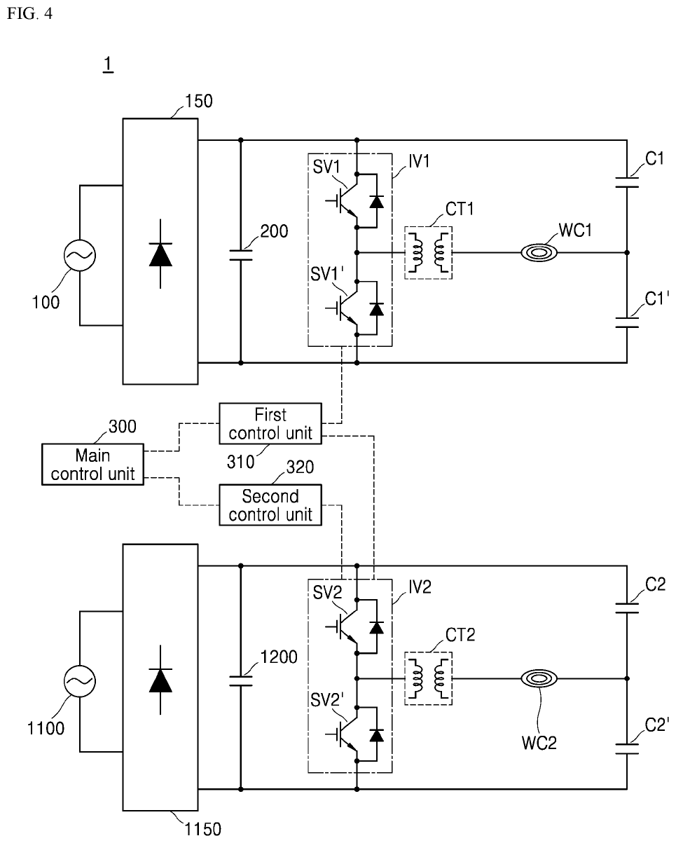

FIG. 4 is a circuit diagram showing an induction heating device according to one embodiment of the present disclosure.

Referring to FIG. 4, an induction heating device 1 according to the present disclosure includes a first board (not shown) having, thereon, a first power supply 100, a first rectifier 150, a first direct-current (DC) link capacitor 200, a first inverter IV1, a first current transformer CT1, a first working coil WC1, a first resonant capacitor set C1 and C1′, and a first control unit 310; and a second board (not shown) having, thereon, a second power supply 1100, a second rectifier 1150, a second direct-current (DC) link capacitor 1200, a second inverter IV2, a second current transformer CT2, a second working coil WC2, a second resonant capacitor set C2 and C2′, and a second control unit 320.

In one embodiment, although not illustrated in the drawing, each of the first and second boards may be implemented, for example, in a form of a printed circuit board (PCB). The induction heating device 1 may further include a main control unit 300 and an input interface (not shown).

In this connection, the first control unit 310 may control operations of various components (e.g., the first inverter IV1, etc.) on the first board. The second control unit 320 may control operations of various components (e.g., the second inverter IV2, etc.) on the second board.

Further, the input interface may be a module that allows a user to input a target heating intensity or a target driving time of the induction heating device. The input interface may be implemented in a various manner including a physical button or a touch panel. The user interface may receive the input from the user and provide the input to the main control unit 300. Then, the main control unit 300 may supply the input received from the input interface to at least one of the first and second control units 310 and 320.

Accordingly, the first control unit 310 controls an operation of the first inverter IV1 based on the input received from the main control unit 300, while the second control unit 320 may control an operation of the second inverter IV2 based on the input received from the main control unit 300. In one embodiment, the first control unit 310 may control the operations of both the first and second inverters IV1 and IV2 based on the input received from the main control unit 300 in a particular situation (e.g., in a flex mode).

However, for convenience of illustration, a more specific example of the input interface may be omitted. Details of the first and second control units 310 and 320 and the main control unit 300 will be described later.

Further, the number of components (for example, inverters, working coils, relays, current transformers, etc.) of the induction heating device as illustrated in FIG. 4 may vary. For convenience of illustration, an example of the induction heating device 1 having the number of components as illustrated in FIG. 4 will be described below. Further, the components disposed on the first board and the components disposed on the second board are the same. Therefore, the components disposed on the first board will be exemplified below.

First, the first power supply 100 may output alternate-current (AC) power.

Specifically, the first power supply 100 may output the alternate-current (AC) power to the first rectifier 150. For example, the AC power may be a commercial power source.

The first rectifier 150 may convert the alternate-current (AC) power supplied from first power supply 100 to direct-current (DC) power and supply the DC power to the first inverter IV1.

Specifically, the first rectifier 150 may rectify the alternate-current (AC) power supplied from the first power supply 100 to convert the AC power to the direct-current (DC) power.

Further, the direct-current (DC) power rectified by the first rectifier 150 may be provided to the first direct-current (DC) link capacitor 200 (that is, a smoothing capacitor) connected in parallel with the first rectifier 150. The first direct-current (DC) link capacitor 200 may reduce a ripple in the direct-current (DC) power.

In one embodiment, the first direct-current (DC) link capacitor 200 may be connected in parallel to the first rectifier 150 and first inverter IV1. Further, the direct-current (DC) voltage may be applied to one end of the direct-current (DC) link capacitor 200, while the other end of the first direct-current (DC) link capacitor 200 may be connected to a ground.

Alternatively, although not illustrated in the figure, the direct-current (DC) power rectified by the first rectifier 150 may be provided to a filter (not shown) rather than to the direct-current (DC). The filter may remove an alternate-current (AC) component from the direct-current (DC) power.

However, in the induction heating device 1 according to one embodiment of the present disclosure, an example in which the direct-current (DC) power rectified by the first rectifier 150 is provided to the direct-current (DC) will be exemplified below.

The first inverter IV1 may perform a switching operation to apply a resonant current to the first working coil WC1.

Specifically, the switching operation for the first inverter IV1 may be controlled by the first control unit (310) as described above. That is, the first inverter IV1 may perform the switching operation based on a switching signal (i.e., a control signal, also referred to as a gate signal) received from the control unit.

In one embodiment, the first inverter IV1 may include two switching elements SV1 and SV1′. The two switching elements SV1 and SV1′ may alternatively be turned on and off in response to the switching signal received from the first control unit (310).

Further, alternating-current (AC) (i.e., resonant current) having a high frequency may be generated by the switching operation of the two switching elements SV1 and SV1′. Then, the generated high-frequency alternate-current (AC) may be applied to the first working coil WC1.

The first working coil WC1 may receive the resonant current from the first inverter IV1. The first working coil WC1 may be connected to the first resonant capacitor set C1 and C1′.

Further, the high-frequency alternate-current (AC) applied from the first inverter IV1 to the first working coil WC1 may enable an eddy current to be generated between the first working coil WC1 and an object (for example, a cooking vessel), so that the object may be heated.

The first current transformer CT may vary a magnitude of the resonant current as output from the first inverter IV1 and transfer the resonant current with the varied magnitude to the first working coil WC1.

Specifically, the first current transformer CT may include a primary stage connected to the first inverter IV1 and a secondary stage connected to the first working coil WC1. Based on a transforming ratio between the primary stage and the secondary stage, the magnitude of the resonant current delivered to the first working coil WC1 may be varied.

For example, when a coil-turns ratio between the primary and secondary stages is 1:320, a magnitude (for example, 80 A) of the resonant current flowing in the primary stage may be reduced by 1/320 to a magnitude (for example, 0.25 A).

In one embodiment, the first current transformer CT may be used to reduce the magnitude of the resonant current flowing in the first working coil WC1 to a magnitude measurable by the first control unit 310.

The first resonant capacitor set C1 and C1′ may be connected to the first working coil WC1.

Specifically, the first resonant capacitor set C1 and C1′ may include a first resonant capacitor C1 and a first further resonant capacitor C1′ as connected in series with each other. The first resonant capacitor set C1 and C1′ may form a first resonant circuit together with the first working coil WC1.

Further, the first resonant capacitor set C1 and C1′ starts to resonate when a voltage is applied thereto via the switching operation of the first inverter IV1. In response, when the first resonant capacitor set C1 and C1′ resonates, the current flowing through the first working coil WC1 connected to the first resonant capacitor set C1 and C1′ may increase.

In this way, an eddy current may be induced to the object disposed on the first working coil WC1 connected to the first resonant capacitor set C1 and C1′.

In a similar manner to the first board as described above, the second board may have the same components thereon (e.g., the second power supply 1100, the second rectifier 1150, the second direct-current (DC) link capacitor 1200, the second inverter IV2 including two switching elements SV2 and SV2′, the second current transformer CT2, the second working coil WC2, the second resonant capacitor set C2 and C2′ and the second control unit 320). Details about this may be omitted.

In one embodiment, the main control unit 300 may receive an input from a user via the input interface. Then, the received input may be provided as at least one of the first and second control units 310 and 320. Further, the first control unit 310 may control the operation of the first inverter IV1 based on the input as received from the main control unit 300, or may control the operations of the first and second inverters IV1 and IV2, based on the input as received from the main control unit 300. The second control unit 320 may control the operation of the second inverter IV2, based on the input as received from the main control unit 300.

The main control unit 300 may exchange information (for example, information related to working coil detection, control-related commands or data, etc.) via communicating with the first and second control units 310 and 320.

Further, the main control unit 300 may determine whether to operate the first and second working coils WC1 and WC2 concurrently, based on the input of the user received from the input interface and the information as received from the first and second control units 310 and 320.

Specifically, when the user's input as received from the input interface indicates a concurrent operation of the first and second working coils WC1 and WC2, the main control unit 300 may determine whether to operate the first and second working coils WC1 and WC2 concurrently, based on an individual coil-based object-detection result for each of the first and second working coils WC1 and WC2, and based on a coil set-based object-detection result for a set of the first and second working coils WC1 and WC2, respectively.

Further, when the concurrent operation of the first and second working coils WC1 and WC2 is determined, the main control unit 300 supplies a control command related to the concurrent operation to the first and second control units 310 and 320. In response, the first and second control units 310 and 320 may realize the concurrent operation of the first and second working coils WC1 and WC2, based on the control command as received from the main control unit 300.

In this connection, when a control command related to the concurrent operation is provided to the first and second control unit 310 and 320, the first control unit 310 may control the operations of both the first and second inverters IV1 and IV2, while the second control unit 320 may stop the control of the second inverter IV2.

Specifically, the concurrent operations of the first and second working coils WC1 and WC2 may be controlled in an in-phase or 180-degrees out-of-phase manner by the first control unit 310.

That is, the first control unit 310 may supply control signals having an in-phase relationship to the first and second inverters IV1 and IV2, respectively. Alternatively, the first control unit 310 may supply control signals having a 180-degrees out-of-phase relationship to the first and second inverters IV1 and IV2, respectively. This allows the concurrent operation of the first and second working coils WC1 and WC2 to be controlled.

In one embodiment, when the first and second working coils WC1 and WC2 operate concurrently, this concurrent operation may achieve a higher power than that from the individual operation. Further, the main control unit 300 may receive information related to the individual coil-based object-detection and to the coil set-based object detection from the first and second control units 310 and 320.

The object-detection method, and the method for determining whether or not to execute the concurrent operation will be described later in detail.

In one embodiment, when the user's input received from the input interface indicates an individual operation between the first and second working coils WC1 and WC2, the first and second control units 310 and 320 may control the individual operations between the first and second working coils WC1 and WC2 based on the user's input as received from the main control unit 300.

Specifically, the first control unit 310 may determine whether to individually operate the first working coil WC1 based on the individual coil-based object-detection result for the first working coil WC1, while the second control unit 320 may determine whether to operate the second working coil WC2 individually based on the individual coil-based object-detection result for the second working coil WC2.

That is, when an object is detected on the first working coil WC1, the first control unit 310 drives the first working coil WC1. When no object is detected on the first working coil WC1, the first control unit 310 does not drive the first working coil WC1.

In the same principle, the second control unit 320 drives the second working coil WC2 when an object is detected on the second working coil WC2. When no object is detected on the second working coil WC2, the second control unit 320 does not drive the second working coil WC2.

In this manner, the first control unit 310 may control the operations of both the first and second inverters IV1 and IV2 based on the input received from the main control unit 300, while the second control unit 320 may control the operation of the second inverter IV2, based on the input as received from the main control unit 300.

Further, the first control unit 310 may determine whether to heat a region corresponding to a region between the first and second working coils WC1 and WC2, based on the user's input received from main control unit 300. Details of this will be described later.

The induction heating device 1 according to one embodiment of the present disclosure may also have a wireless power transfer function, based on the configurations and features as described above.

That is, in recent years, a technology for supplying power wirelessly has been developed and applied to many electronic devices. An electronic device with the wireless power transmission technology may charge a battery by simply placing the battery on a charging pad without connecting the battery to a separate charging connector. An electronic device to which such a wireless power transmission is applied does not require a wire cord or a charger, so that portability thereof is improved and a size and weight of the electronic device are reduced compared to the prior art.

Such a wireless power transmission system may include an electromagnetic induction system using a coil, a resonance system using resonance, and a microwave radiation system that converts electrical energy into microwave and transmits the microwave. The electromagnetic induction system may execute wireless power transmission using an electromagnetic induction between a primary coil (for example, the first and second working coils WC1 and WC2) provided in a unit for transmitting wireless power and a secondary coil included in a unit for receiving the wireless power.

The induction heating device 1 heats the loaded-object via electromagnetic induction. Thus, the operation principle of the induction heating device 1 may be substantially the same as that of the electromagnetic induction-based wireless power transmission system.

Therefore, the induction heating device 1 according to one embodiment of the present disclosure may have the wireless power transmission function as well as induction heating function. Furthermore, an induction heating mode or a wireless power transfer mode may be controlled by the main control unit (300). Thus, if desired, the induction heating function or the wireless power transfer function may be selectively used.

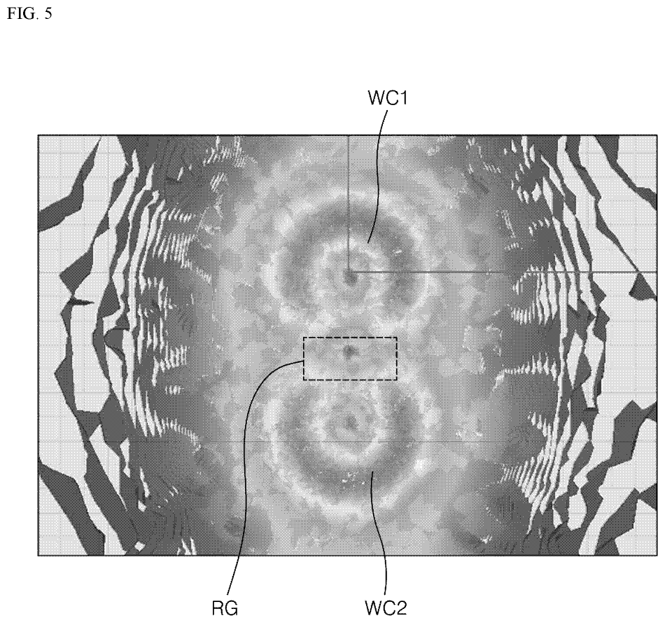

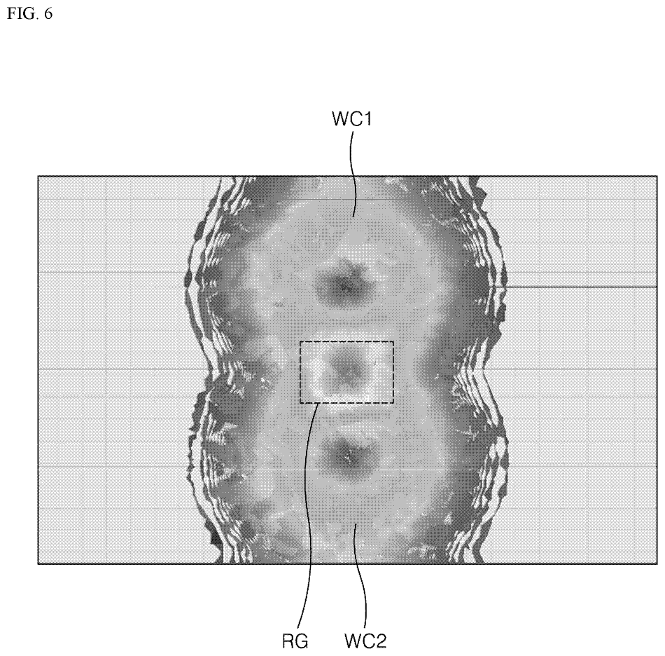

The induction heating device 1 may have the configuration and features described above. Hereinafter, with reference to FIGS. 5 and 6, a control signal delivery scheme using the first control unit 310 will be described.

FIG. 5 is a schematic diagram illustrating a heated-region by a working coil according to an in-phase control signal delivery by a first control unit of FIG. 4. FIG. 6 is a circuit diagram illustrating a heated-region by a working coil according to a 180-degrees out-of-phase control signal delivery by the first control unit of FIG. 4.

First, referring to FIG. 4 and FIG. 5, the first control unit 310 may determine whether or not to heat a region corresponding to a region between the first and second working coils WC1 and WC2 based on the user input as received from the main control unit 300.

Specifically, when the input provided by the user to the input interface indicates the region between the first and second working coils WC1 and WC2 as a non-target heated region (for example, a poorly-heated region), the first control unit 310 may supply control signals having an in-phase relationship to the first and second inverters IV1 and IV2, respectively.

Further, when the first control unit 310 supplies the control signals having the same frequency and the in-phase relationship to the first and second inverters IV1 and IV2, respectively, the first and second working coils WC1 and WC2 may be driven at an in-phase and at the same frequency, heating is concentrated on the region corresponding to the edges of the working coils WC1 and WC2. Thereby, heat may be concentrated on a region of the object corresponding to the edges of the working coils WC1 and WC2.

That is, when the first and second working coils WC1 and WC2 are driven at the same frequency and at an in-phase, the region corresponding to the region between the first and second working coils WC1 and WC2 may be set to a non-target heated region. Regions corresponding to remaining edges of the first and second working coils WC1 and WC2, except for the non-target heated region may be heated by the first and second working coils WC1 and WC2.

In this connection, referring to FIG. 5, heating is concentrated on the regions corresponding to the edges of the working coils WC1 and WC2. The region RG corresponding to the region between the first and second working coils WC1 and WC2 may set to be a non-target heated region (i.e., a poorly-heated region).

On the other hand, referring to FIG. 4 and FIG. 6, when the input provided by the user to the input interface indicates the region corresponding to the region between the first and second working coils WC1 and WC2 as the target heated region, the first control unit 310 may supply control signals having a 180-degrees out-of-phase relationship to the first and second inverters IV1 and IV2, respectively.

Further, when the first control unit 310 supplies the control signals having the same frequency and the 180-degrees out-of-phase relationship to the first and second inverters IV1 and IV2, respectively, the first and second working coils WC1 and WC2 may be driven at the 180 degrees out-of-phase and at the same frequency. Accordingly, the first working coil WC1 may be driven at the same frequency as and at the 180-degrees out-of-phase from the second working coil WC2, heating is concentrated on the region corresponding to the region between the working coils WC1 and WC2. The heating-concentrated region of the object may correspond to the region between the working coils WC1 and WC2.

That is, when the first working coil WC1 may be driven at the same frequency as the second working coil WC2 but at an out-of-phase by 180 degrees from a phase of the second working coil, the region corresponding to the region between the working coils WC1 and WC2 may be set to a target heated region, which, in turn, may be primarily heated by the working coils WC1 and WC2.

In this connection, referring to FIG. 6, the region RG corresponding to the region between each working coil WC1 and WC2 may be set to the target heated region. Thus, the heating is concentrated on the corresponding region RG.

When the input provided by the user to the input interface indicates the region corresponding to the region between the first and second working coils WC1 and WC2 as the target heated region or the non-target heated region, the second control unit 320 may stop controlling the second inverter IV2. That is, when the input provided by the user to the input interface indicates the concurrent operation (i.e., the flex mode) of the first and second working coils WC1 and WC2, only the first control unit 310 controls both the first and second inverters IV1 and IV2, while the second control unit 320 does not control any inverter.

In this way, since, during the concurrent operation of the first and second working coils WC1 and WC2, the first control unit 310 controls the operations of both the first and second inverters IV1 and IV2, an unexpected phase difference between the first and second working coils WC1 and WC2 due to component property variations may be minimized. Thus, minimizing the unintentional phase difference may allow a power consumption vibration to be minimized.

In one embodiment of the present disclosure, an example is illustrated in which only the first control unit 310 controls the operations of both the first and second inverters IV1 and IV2 in the concurrent operation of the first and second working coils WC1 and WC2 has been illustrated. However, the present disclosure is not limited thereto.

Alternatively, only the second control unit 320, not the first control unit 310 may control the operations of both the first and second inverters IV1 and IV2 during the concurrent operation of the first and second working coils WC1 and WC2. Alternatively, the first control unit 310 or the second control unit 320 may control the operations of both the first and second inverters IV1 and IV2 during the concurrent operation of the first and second working coils WC1 and WC2.

However, for convenience of illustration, in one embodiment of the present disclosure, am example in which the first control unit 310 controls the operations of both the first and second inverters IV1 and IV2 during concurrent operation of the first and second working coils WC1 and WC2 has been illustrated.

Further, although not shown in the figure, when power supplies (not shown) for the first and second control units 310 and 320 are different, a first insulation-type circuit (not shown; for example, a photo transistor) may be further disposed on the first board.

In this case, when the first and second working coils WC1 and WC2 operate concurrently, the first control unit 310 directly controls the first inverter IV1, while the first control unit 310 controls the second inverter IV2 via the first insulation-type circuit.

Specifically, when the first and second working coils WC1 and WC2 operate concurrently, the first control unit 310 may provide the control signal directly to the first inverter IV1, while the first control unit 310 may supply a secondary-side signal of the first insulation-type circuit to the second inverter IV2.

That is, when the first control unit 310 supplies the control signal to the first insulation-type circuit, the first insulation-type circuit may feed to the second inverter IV2 the secondary-side signal for the control signal received from the first control unit 310.

Alternatively, when the second control unit 320 controls the operations of both the first and second inverters IV1 and IV2 during the concurrent operation of the first and second working coils WC1 and WC2, a second insulation-type circuit (not shown) may be disposed on the second board.

However, for convenience of illustration, in one embodiment of the present disclosure, an example in which there is a common power supply for the first and second control units 310, 320 (i.e., the insulation-type circuit is not required) will be exemplified.

In this manner, the induction heating device 1 may improve the heated-region control and high-power performance via the improvement of the control signal delivery scheme.

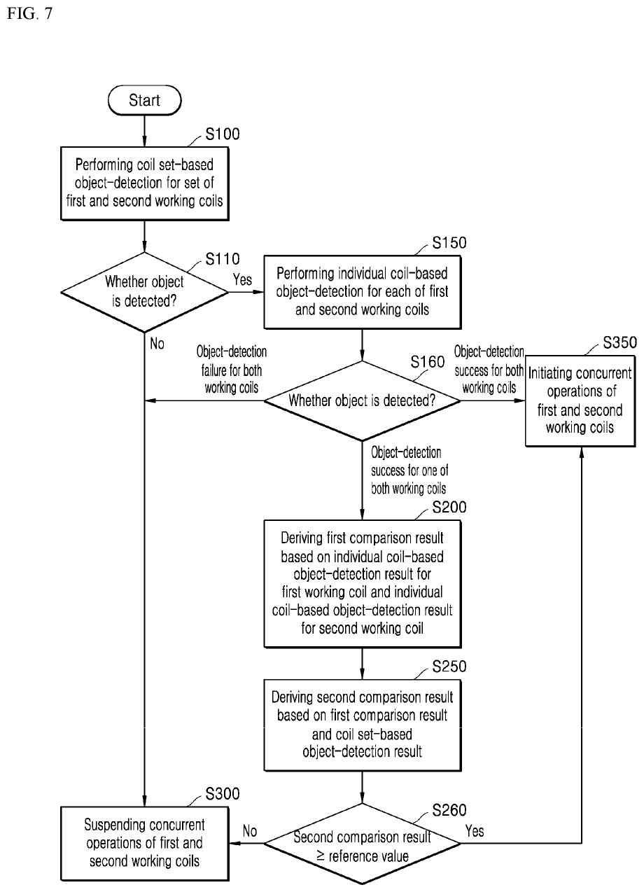

Hereinafter, an object-detection method by the induction heating device 1 will be described with reference to FIG. 7.

FIG. 7 is a flow chart illustrating an object-detection method by the induction heating device of FIG. 4.

In one embodiment, referring to FIG. 7, an object-detection algorithm is illustrated when the induction heating device 1 is driven in a flex mode.

That is, when the working coils (for example, the first and second working coils WC1 and WC2 of FIG. 4) in the induction heating device 1 are driven in the individual mode, only the individual coil-based object-detection for each of the working coils (e.g., the first and second working coils WC1 and WC2 of FIG. 4) may be performed by the first and second control units 310 and 320.

However, in the flex mode, a different object-detection algorithm may be performed, as illustrated in FIG. 7.

Referring to FIG. 4 and FIG. 7, first, the coil set-based object-detection for the set of the first and second working coils WC1 and WC2 may be performed (S100).

Specifically, when the user input as received by the control unit via the input interface indicates the flex mode (i.e., concurrent operations of the first and second working coils WC1 and WC2), the main control unit 300 together with the first and second control units 310 and 320 may perform the coil set-based object-detection for the set of the first and second working coils WC1 and WC2,

In one embodiment, the coil set-based object-detection for the set of the first and second working coils WC1 and WC2 may be performed as follows: a total power consumption of the first and second working coils WC1 and WC2, and a sum of the resonant currents flowing in the first and second working coils WC1 and WC2 may be acquired. Then, the control unit may determine, based on at least one of the total power consumption and the sum of the resonant currents, detect whether or not an object is loaded on the first and second working coils WC1 and WC2.

In other words, when an object is located on a specific working coil (S110), the resistance of the object may increase the overall resistance. As a result, attenuation of the resonant current flowing through the specific working coil may be increased.

The first control unit 310 may detect the resonant current flowing in the first working coil WC1 based on the above-defined principle. Then, the first control unit 310 may calculate at least one of a power consumption and a resonant current of the first working coil WC based on the detected resonant current value. Further, the first control unit 310 may provide the calculation result (i.e., information related to the coil set-based object detection) to the main control unit 300.

In the same manner, the second control unit 320 may detect the resonant current flowing in the second working coil WC2. Then, the second control unit 320 may calculate at least one of a power consumption and a resonant current of the second working coil WC2 based on the detected resonant current value. Further, the second control unit 320 may provide the calculation result (i.e., information related to the coil set-based object detection) to the main control unit 300.

The main control unit 300 may calculate at least one of the total power consumption, and a sum of the resonant currents for the first and second working coils WC1 and WC2, based on the calculation results (i.e., information related to the coil set-based object detection) as respectively received from the first and second control units 310 and 320. Further, the main control unit 300 may detect whether an object is disposed on the first and second working coils WC1 and WC2 based on the calculation result.

Then, when the object is determined not to be detected based on the coil set-based object-detection result for the set of the first and second working coils WC1 and WC2 (S110), the concurrent operations of the first and second working coils WC1 and WC2 may be suspended (S300).

Specifically, when the object is determined not to be detected based on the coil set-based object-detection result for the set of the first and second working coils WC1 and WC2 (S110), the main control unit 300 may determine to disallow the concurrent operations of the first and second working coils WC1 and WC2. In this case, when, subsequently, the user's input (that is, a command for the concurrent operation) is provided via the input interface, the main control unit 300 may perform the above-described detection again based on the corresponding user input.

Conversely, when the object is determined to be detected based on the coil set-based object-detection result for the set of the first and second working coils WC1 and WC2 (S110), the individual coil-based object-detection for each of the first and second working coils WC1 and WC2 may be executed (S150).

Specifically, the individual coil-based object-detection for the first working coil WC1 is performed as follows: whether or not an object exists on the first working coil WC1 may be determined based on the at least one of the resonant current flowing through the first working coil WC1 and the power consumption of the first working coil WC1.

In this connection, the first control unit 310 may perform the individual coil-based object detection for the first working coil WC1. The control unit 310 may provide the individual coil-based object-detection result for the first working coil WC1 (i.e., information related to the individual coil-based object detection) to the main control unit 300.

Further, the individual coil-based object-detection for the second working coil WC2 is performed as follows: whether an object exists on the second working coil WC2 may be determined based on at least one of the resonant current flowing through the second working coil WC2 and a power consumption of the second working coil WC2.

In this connection, the second control unit 310 may perform the individual coil-based object detection for the second working coil WC2. The second control unit 320 may provide the individual coil-based object-detection result for the second working coil WC2 (i.e., information related to the individual coil-based object detection) to the main control unit 300.

When it is determined, based on the individual coil-based object-detection results for the first and second working coils WC1 and WC2 respectively, that the object has not been loaded on both the first and second working coils WC1 and WC2 (S160), the concurrent operations of the first and second working coils WC1 and WC2 may be suspended (S300).

More specifically, when it is determined, based on the individual coil-based object-detection results for the first and second working coils WC1 and WC2 (S160), that the object has not been loaded on both the first and second working coils WC1 and WC2, the main control unit 300 may determine not to operate the first and second working coils WC1 and WC2 concurrently. In this case, when, subsequently, the user's input (that is, a command for the concurrent operation) is provided via the input interface, the control unit may perform the above-described detection again based on the corresponding user input.

Conversely, when it is determined, based on the individual coil-based object-detection results for the first and second working coils WC1 and WC2 (S160), that the object has been loaded on both the first and second working coils WC1 and WC2, the concurrent operations of the first and second working coils WC1 and WC2 may be initiated (S350).

More specifically, when it is determined, based on the individual coil-based object-detection results for the first and second working coils WC1 and WC2 (S160), that the object has been loaded on both the first and second working coils WC1 and WC2, the main control unit 300 may determine to operate the first and second working coils WC1 and WC2 concurrently.

In this case, the main control unit 300 may provide the control command related to the concurrent operation to the first and second control units 310 and 320. Then, the first control unit 310 may enable the concurrent operations of the first and second working coils WC1 and WC2 (that is, which concurrently operate either at an in-phase or at a 180-degrees out-of-phase), based on the control command as received from the main control unit 300,

Alternatively, when it is determined, based on the individual coil-based object-detection results for the first and second working coils WC1 and WC2 (S160), that the object has been loaded on only one of the first and second working coils WC1 and WC2, the control unit may derive a first comparison result based on an individual coil-based object-detection result for the first working coil WC1 and an individual coil-based object-detection result for the second working coil WC2 (S200).

More specifically, when it is determined, based on the individual coil-based object-detection results for the first and second working coils WC1 and WC2 (S160), that the object has been loaded on only one of the first and second working coils WC1 and WC2, the main control unit 300 may compare the individual coil-based object-detection result (e.g., the power consumption of the first working coil WC1) for the first working coil WC1 and the individual coil-based object-detection result (for example, the power consumption of the second working coil WC2) for the second working coil WC2. This comparison result may be referred to as the first comparison result. For example, based on the first comparison, the power consumption of the first working coil WC1 may be greater than the power consumption of the second working coil WC2.

When the first comparison result has been derived (S200), the main control unit derives a second comparison result based on the first comparison result and the coil set-based object-detection result (S250).

Specifically, the main control unit 300 may derive the second comparison result, based on the coil set-based object-detection result (e.g. the total power consumption of the first and second working coils WC1 and WC2) for the set of the first and second working coils WC1 and WC2, and based on the first comparison result (e.g., the power consumption of the first working coil WC1 being greater than the power consumption of the second working coil WC2). In one example, the second comparison result may be derived via comparison between the total power consumption of the first and second working coils WC1 and WC2 and the power consumption of the first working coil WC1, or may be derived based a difference between the total power consumption of the first and second working coils WC1 and WC2 and the power consumption of the first working coil WC1.

When the second comparison result has been obtained, the control unit determines whether the second comparison result satisfies a predetermined condition (S260).

Specifically, the main control unit 300 compares the second comparison result (e.g., the difference between the total power consumption of the first and second working coils WC1 and WC2 and the power consumption of the first working coil WC1) with a reference value. In this connection, the reference value may mean a minimum or average power consumption value of the corresponding working coil when the object is loaded on the working coil. Alternatively, the reference value may be preset.

When the second comparison result (e.g., the difference between the total power consumption of the first and second working coils WC1 and WC2 and the power consumption of the first working coil WC1) is equal to or greater than the reference value (the minimum or average power consumption value of the first corresponding working coil when the object is loaded on the first working coil), the concurrent operations of the first and second working coils WC1 and WC2 may be initiated (S350).

That is, when the second comparison result is greater than or equal to the reference value, the main control unit 300 may determine to operate the first and second working coils WC1 and WC2 concurrently. In this case, the single object may be heated by both the first and second working coils WC1 and WC2.

Conversely, when the second comparison result is smaller than the reference value, the control unit may not operate the first and second working coils WC1 and WC2 concurrently. That is, the concurrent operation of the first and second working coils WC1 and WC2 may be suspended (S300).

That is, when the second comparison result is smaller than the reference value, the main control unit 300 may determine not to operate the first and second working coils WC1 and WC2 concurrently. In this case, when, subsequently, the user's input (that is, a command for the concurrent operation) is provided via the input interface, the control unit may perform the above-described detection again based on the corresponding user input.

The above-described method and process may realize the object-detection when the induction heating device 1 is driven in the flex mode.

In the induction heating device 1 according to one embodiment of the present disclosure, the object-detection algorithm when the device is running in the flex mode may be improved. Thus, the user may easily check whether an object on an area corresponding to an area between the working coils is correctly positioned for enablement of the flex mode. Thus, a burden that the user should place the object on a correct position for driving of the induction heating device in the flex mode may be eliminated. Thus, user convenience may be improved.

Further, in the induction heating device 1 according to one embodiment of the present disclosure, the improved control signal delivery scheme may improve heating-region control and high-power performance. This reduces the object heating time and improves the accuracy of the heating intensity adjustment. Further, the object heating time reduction, and improved heating intensity adjustment accuracy may result in shorter cooking timing by the user, thereby resulting in improved user satisfaction.

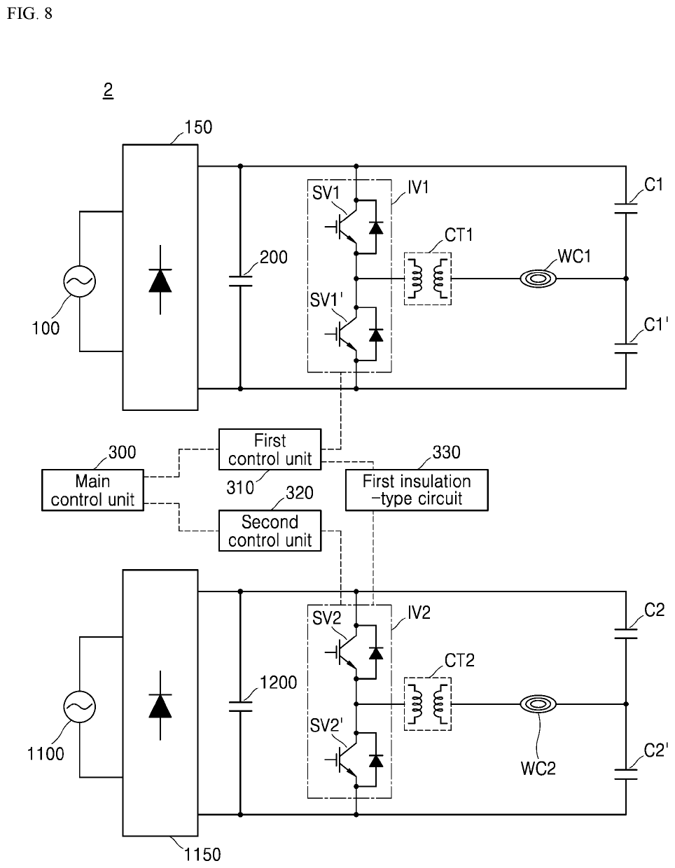

Hereinafter, referring to FIG. 8, an induction heating device 2 according to another embodiment of the present disclosure will exemplified.

In one embodiment, the induction heating device 2 of FIG. 8 is identical, in terms of configuration and effect thereof, with the induction heating device 1 of FIG. 4, except for the presence and function of the first insulation-type circuit 330. Therefore, the differences between these devices 1 and 2 will be mainly illustrated.

Unlike the induction heating device 1 in FIG. 4, referring to FIG. 8, the induction heating device 2 according to another embodiment of the present disclosure may further include a first insulation-type circuit 330 that may invert or non-invert the control signal generated from the first control unit 310.

Specifically, the first insulation-type circuit 330 may be disposed on a first board (not shown). Further, during the concurrent operations of the first and second working coils WC1 and WC2, the first insulation-type circuit 330 may receive a control signal from the first control unit 310 and, then, may invert or non-invert the phase of the received control signal, which, in turn may be provided to the second inverter IV2.

That is, in the induction heating device 1 of FIG. 4, when a control command related to the concurrent operation of the first and second working coils WC1 and WC2 is provided to the first control unit 310, the first control unit 310 directly generates control signals having an in-phase or 180-degrees out-of-phase relationship, and provides them to the first and second inverters IV1 and IV2, respectively.

However, in the induction heating device 2 of FIG. 8, when a control command related to the concurrent operation of the first and second working coils WC1 and WC2 is provided to the first control unit 310, the first control unit 310 may generate only in-phase control signals.

In this regard, the control signal generated from the first control unit 310 may be provided directly to the first inverter IV1, while, at the same time, the first insulation-type circuit 330 may receive the control signal from the first control unit 310, and, then, invert or invert the phase of the control signal and then provide them to the second inverter IV2.

That is, the control signal as generated from the first control unit 310 may be provided directly to the first inverter IV1, while the control signal having a phase as inverted or non-inverted by the first insulation-type circuit 330 may be supplied to the second inverter IV2.

Accordingly, when the input received from the main control unit 300 of the first control unit 310 indicates a region corresponding to the region between the first and second working coils WC1 and WC2 as a non-target heated region, the control signal as generated from the first control unit 310 may be provided directly to the first inverter IV1, while the control signal having a phase as non-inverted by the first insulation-type circuit 330 may be supplied to the second inverter IV2.

Conversely, when the input received from the main control unit 300 of the first control unit 310 indicates a region corresponding to the region between the first and second working coils WC1 and WC2 as a target heated region, the control signal as generated from the first control unit 310 may be provided directly to the first inverter IV1, while the control signal having a phase as inverted by the first insulation-type circuit 330 may be supplied to the second inverter IV2.

The first insulation-type circuit 330 in this embodiment of the present disclosure may be different from the first insulation-type circuit (not shown) in the previous embodiment of the present disclosure.

Specifically, the first insulation-type circuit (not shown) in the previous embodiment of the present disclosure may be present only when the power supplies for the first and second control units 310 and 320 are different from each other. That is, the first insulation-type circuit (not shown) in the previous embodiment of the present disclosure is not directed to the inversion of the phase of the signal.

However, the first insulation-type circuit 330 in this embodiment of the present disclosure exists regardless of whether the power supplies for the first and second working coils are the same.

That is, the first insulation-type circuit 330 may be configured for inverting a signal (that is, inverting a high signal (e.g., 1) to a low signal (e.g., 0) or inverting a low signal to a high signal), or for non-inverting a signal (that is, outputting a high signal or a low signal as it is).

In this embodiment of the present disclosure, there has been illustrated the example wherein only the first control unit 310 controls the operations of both the first and second inverters IV1 and IV2 when the first and second working coils WC1 and WC2 operate concurrently. However, the present disclosure is not limited thereto.

Alternatively, only the second control unit 320, not the first control unit 310, may control the operations of both the first and second inverters IV1 and IV2 during the concurrent operation of the first and second working coils WC1 and WC2. In this case, a second insulation-type circuit (not shown) may be disposed on the second board.

Alternatively, the first control unit 310 or the second control unit 320 may control the operations of both the first and second inverters IV1 and IV2 during the concurrent operation of the first and second working coils WC1 and WC2, In this case, the first insulation-type circuit 330 may be disposed on the first board, while a second insulation-type circuit (not shown) may be disposed on the second board.

However, for convenience of illustration, in the above embodiment of the present disclosure, there has been illustrated the example wherein the first control unit 310 controls the operations of both the first and second inverters IV1 and IV2 when the first and second working coils WC1 and WC2 operate concurrently.

In the above description, numerous specific details are set forth in order to provide a thorough understanding of the present disclosure. The present disclosure may be practiced without some or all of these specific details. Examples of various embodiments have been illustrated and described above. It will be understood that the description herein is not intended to limit the claims to the specific embodiments described. On the contrary, it is intended to cover alternatives, modifications, and equivalents as may be included within the spirit and scope of the present disclosure as defined by the appended claims.

What is claimed is:

1. An induction heating device comprising:
a first board that comprises:
a first working coil,
a first inverter configured to perform a first switching operation and to apply a first resonant current to the first working coil based on the first switching operation, and
a first control unit configured to control operation of the first inverter; and
a second board that comprises:
a second working coil,
a second inverter configured to perform a second switching operation and to apply a second resonant current to the second working coil based on the second switching operation, and
a second control unit configured to control operation of the second inverter,
wherein the first control unit is configured to enable the first working coil and the second working coil to operate concurrently at an in-phase state or at an out-of-phase state by 180 degrees.

2. The induction heating device of claim 1, further comprising a main control unit that is configured to:
receive an input from a user through an input interface; and
provide the input to at least one of the first control unit or the second control unit.

3. The induction heating device of claim 2, wherein the first control unit is configured to, based on the input received from the main control unit, control one of operation of the first inverter or operation of both of the first inverter and the second inverter, and
wherein the second control unit is configured to, based on the input received from the main control unit, control operation of the second inverter.

4. The induction heating device of claim 3, wherein the main control unit is further configured to, in response to reception of an input indicating a concurrent operation of the first working coil and the second working coil:
perform a first object detection to determine, based on a measure related to a set of the first working coil and the second working coil, whether one or more objects are located at an area of the induction heating device corresponding to at least one of the first working coil or the second working coil;
control each of the first control unit and the second control unit to perform a second object detection to determine, based on a measure related to each of the first working coil and the second working coil, whether an object is located at an area of the induction heating device corresponding to each of the first working coil and the second working coil; and
determine performance of the concurrent operation of the first working coil and the second working coil (i) based on a result from the first object detection and (ii) based on results from the second object detection.

5. The induction heating device of claim 3, wherein the first control unit is further configured to, in response to reception of an input indicating an individual operation of the first working coil or the second working coil:
perform an object detection to determine whether a first object is located at a first area of the induction heating device corresponding to the first working coil; and
determine performance of the individual operation of the first working coil based on a result from the object detection indicating that the first object is located at the first area of the induction heating device corresponding to the first working coil, and
wherein the second control unit is further configured to, in response to reception of the input indicating the individual operation of the first working coil or the second working coil:
perform the object detection to determine whether a second object is located at a second area of the induction heating device corresponding to the second working coil, and
determine performance of the individual operation of the second working coil based on a result from the object detection indicating that the second object is located at the second area of the induction heating device corresponding to the second working coil.

6. The induction heating device of claim 2, wherein the first control unit is further configured to, based on the input received from the main control unit, determine whether to heat a first region of the induction heating device located between the first working coil and the second working coil.

7. The induction heating device of claim 6, wherein the first control unit is further configured to, in response to reception of an input indicating that the first region of the induction heating device does not correspond to a target heating region, provide a first control signal to the first inverter and a second control signal to the second inverter, the second control signal being in phase with the first control signal.

8. The induction heating device of claim 6, wherein the first control unit is further configured to, in response to reception of an input indicating that the first region of the induction heating device corresponds to a target heating region, provide a first control signal to the first inverter and a second control signal to the second inverter, the second control signal being out of phase from the first control signal by 180 degrees.

9. The induction heating device of claim 6, wherein the main control unit is further configured to:
set the first region of the induction heating device as a non-target region; and
drive the first working coil and the second working coil at a same frequency in the in-phase state to heat second regions of the induction heating device corresponding to edges of the first working coil and the second working coil, the second regions being outside of the first region.

10. The induction heating device of claim 6, wherein the main control unit is further configured to:
set the first region of the induction heating device to a target heating region;
drive the first working coil and the second working coil at a same frequency in the out-of-phase state by 180 degrees to heat the target heating region.

11. The induction heating device of claim 1, wherein the first board further comprises a first insulation-type circuit that is configured to transmit a control signal to the second inverter based on a power supply for the second control unit being different from a power supply for the first control unit.

12. The induction heating device of claim 11, wherein the first control unit is further configured to control the first inverter directly and to control the second inverter through the first insulation-type circuit to concurrently operate the first working coil and the second working coil.

13. The induction heating device of claim 1, wherein the first board further comprises:
a first resonant capacitor connected to the first working coil; and
a first current transformer configured to adjust a magnitude of the first resonant current output from the first inverter and to transmit the first resonant current having the adjusted magnitude to the first working coil, and
wherein the second board further comprises:
a second resonant capacitor connected to the second working coil, and
a second current transformer configured to adjust a magnitude of the second resonant current output from the second inverter and to transmit the second resonant current having the adjusted magnitude to the second working coil.

14. An induction heating device comprising:
a first board that comprises:
a first working coil,
a first inverter configured to perform a first switching operation and to apply a first resonant current to the first working coil based on the first switching operation, and
a first control unit configured to control operation of the first inverter; and
a second board that comprises:
a second working coil,
a second inverter configured to perform a second switching operation and to apply a second resonant current to the second working coil based on the second switching operation, and
a second control unit configured to control operation of the second inverter,
wherein at least one of the first control unit or the second control unit is configured to enable the first working coil and the second working coil to operate concurrently at an in-phase state or at an out-of-phase state by 180 degrees.

15. The induction heating device of claim 14, wherein the first board further comprises a first insulation-type circuit that is configured to transmit a control signal to the second inverter based on a power supply for the second control unit being different from a power supply for the first control unit, and
wherein the second board further comprises a second insulation-type circuit that is configured to transmit a control signal to the first inverter based on the power supply for the second control unit being different from the power supply for the first control unit.

16. An induction heating device comprising:
a first board that comprises:
a first working coil,
a first inverter configured to perform a first switching operation and to apply a first resonant current to the first working coil based on the first switching operation, and
a first control unit configured to control operation of the first inverter by a first control signal,
a first insulation-type circuit that is configured to receive a second control signal generated from the first control unit; and
a second board that comprises:
a second working coil,
a second inverter configured to perform a second switching operation and to apply a second resonant current to the second working coil based on the second switching operation, and
a second control unit configured to control operation of the second inverter,
wherein the first control unit is further configured to directly provide the first control signal to the first inverter to concurrently operate the first working coil and the second working coil, and
wherein the first insulation-type circuit is further configured to, in a state in which the first control unit directly provides the first control signal to the first inverter:
receive the second control signal from the first control unit,
generate one of an inverted control signal by inverting a phase of the second control signal or a non-inverted control signal by maintaining the phase of the second control signal, and
provide the inverted control signal or the non-inverted control signal to the second inverter to concurrently operate the first working coil and the second working coil.

17. The induction heating device of claim 16, further comprising a main control unit that is configured to:
receive an input from a user through an input interface; and
provide the input to at least one of the first control unit or the second control unit.

18. The induction heating device of claim 17, wherein the first control unit is further configured to, based on the input received from the main control unit, determine whether to heat a first region of the induction heating device located between the first working coil and the second working coil.

19. The induction heating device of claim 18, wherein the first control unit is further configured to, based on the input indicating that the first region does not correspond to a target heating region, provide the first control signal directly to the first inverter while the first insulation-type circuit generates the non-inverted control signal and provides the non-inverted control signal to the second inverter.

20. The induction heating device of claim 18, wherein the first control unit is further configured to, based on the input indicating that the first region corresponds to a target heating region, provide the first control signal directly to the first inverter while the first insulation-type circuit generates the inverted control signal and provides the inverted control signal to the second inverter.
